(19) United States
(12) Patent Application Publication
(10) Pub. No.: US 2010/0207868 A1
(43) Pub. Date: Aug. 19, 2010

(54) DISPLAY PARTICLES FOR IMAGE DISPLAY APPARATUS AND IMAGE DISPLAY APPARATUS USING THE SAME

(75) Inventors: Hiroyuki KONNO, Tokyo (JP); Okushi OKUYAMA, Tokyo (JP); Yukio HOSOYA, Tokyo (JP); Satoshi UCHINO, Tokyo (JP); Kouji SHIBATA, Tokyo (JP); Tatsuya NAGASE, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/706,325

(22) Filed: Feb. 16, 2010

(30) Foreign Application Priority Data
Feb. 16, 2009 (JP) 2009032723

(51) Int. Cl. G09G 3/34

(52) U.S. Cl. 345/107

(57) ABSTRACT

Display particles that are used for an image display apparatus in which the display particles are sealed between two substrates at least one of which is transparent, and by generating an electric field between the substrates, the display particles are moved so that an image is displayed, wherein the display particles include positively chargeable display particles and negatively chargeable display particles, and the positively chargeable display particles and the negatively chargeable display particles are formed by allowing inorganic fine particles made of the same constituent materials to be adhered to the surfaces of base particles, and an image display apparatus provided with the display particles.

This application is based on application(s) No. 2009-032723 filed in Japan, the contents of which are hereby incorporated by reference.

### BACKGROUND OF THE INVENTION

1. Field of the Invention

The present invention relates to display particles to be used in an image display apparatus that can repeatedly execute displaying and erasing operations of images by applying an electric field to charged display particles so as to move the display particles, and an image display apparatus.

2. Description of the Related Art

Conventionally, an image display system has been known in which charged display particles are sealed in a gaseous phase, and by applying a voltage so as to move the display particles in the electric field direction, an image displaying operation is carried out. In this system, by applying a voltage between substrates, the charged display particles need to be moved in the electric field direction thus formed; therefore, there has been a demand for a technique that can move the display particles smoothly even under a low applied voltage.

The display particles are formed by externally adding external additives such as inorganic fine particles to base particles, and conventionally, positively chargeable display particles and negatively chargeable display particles are mixed with each other and used. The chargeability of each kind of these can be controlled by the chargeability of the externally added inorganic fine particles and a charge-controlling agent or the like contained in the base particles on demand (JP-A No. 2004-29699, JP-A No. 2006-72345, JP-A No. 2007-171482).

However, when such display particles are used, the charging balance is upset upon repeatedly carrying out image displaying and erasing operations, resulting in a problem in that the contrast between an image portion and a non-image portion is lowered.

### BRIEF SUMMARY OF THE INVENTION

An object of the present invention is to provide display particles that can repeatedly display images having sufficiently high contrast between an image portion and a non-image portion and an image display apparatus that is provided with such display particles.

The present invention relates to display particles that are used for an image display apparatus in which the display particles are sealed between two substrates at least one of which is transparent, and by generating an electric field between the substrates, the display particles are moved so that an image is displayed, wherein the display particles include positively chargeable display particles and negatively chargeable display particles, and the positively chargeable display particles and the negatively chargeable display particles are formed by allowing inorganic fine particles made of the same constituent materials to be adhered to the surfaces of base particles, and the present invention also relates to an image display apparatus provided with the display particles.

### BRIEF DESCRIPTION OF THE DRAWINGS

FIG. 1 is a schematic drawing that shows a cross-sectional structure of an image display apparatus.

FIG. 2 is a schematic drawing that shows an example of movements of display particles by a voltage application between base members.

FIG. 3 is a schematic drawing that shows an example of movements of display particles by a voltage application between base members.

FIG. 4 is a schematic drawing that shows an example of a shape of an image display surface.

FIG. 5 is a schematic drawing that shows one example of a sealing method for display particles.

FIG. 6 is a schematic drawing that shows another example of a sealing method for display particles.

### DETAILED DESCRIPTION OF THE INVENTION

The present invention relates to display particles that are used for an image display apparatus in which the display particles are sealed between two substrates at least one of which is transparent, and by generating an electric field between the substrates, the display particles are moved so that an image is displayed, wherein the display particles include positively chargeable display particles and negatively chargeable display particles, and the positively chargeable display particles and the negatively chargeable display particles are formed by allowing inorganic fine particles made of the same constituent materials to be adhered to the surfaces of base particles.

In accordance with the present invention, it is possible to repeatedly display images having sufficiently high contrast between an image portion and a non-image portion.

Display Particles for Image Display Apparatus

The display particles for an image display apparatus (hereinafter, simply referred to as display particles) in accordance with the present invention comprise positively chargeable display particles and negatively chargeable display particles. As a method for charging electrically the display particles, such a method as toner is electrically charged in accordance with an electrophotographic principle may be used. The charging polarity of the display particles can be controlled by handling the display particles in a manner similar to the toner. For example, those particles to be used for the positively chargeable display particles are charged by using a carrier normally formed by coating a core surface with a fluorinated acrylate resin. Those particles to be used for the negatively chargeable display particles are charged by using a carrier formed by coating a core surface with cyclohexyl methacrylate. As a result, the positively chargeable display particles charged to the positive polarity and the negatively chargeable display particles charged to the negative polarity are obtained, and used as display particles relating to the present invention. The positively chargeable display particles and the negatively chargeable display particles are normally different from each other not only in charged polarities, but also in colors; therefore; upon generation of an electric field between substrates in an image display apparatus, which will be described in detail, a display image can be visually recognizable based upon a difference in the colors between those display particles that are moved toward the substrate on the upstream side in the visually recognizable direction and adhered thereto and those display particles that are moved toward the substrate on the downstream side in the visually recognizable direction and adhered thereto. For example, one of positively chargeable display particles and negatively chargeable display particles may be colored into white, while the other thereof may be colored into black, so that a display image becomes visually recognizable.

In the present invention, the positively chargeable display particles and the negatively chargeable display particles are formed by allowing inorganic fine particles made of the same constituent materials to be adhered to the surfaces of base particles. With this arrangement, during repeated displaying operations, even when the adhered inorganic fine particle is moved between a base particle of the positively chargeable display particle and a base particle of the negatively chargeable display particle, the chargeability and physical adhesive property of each particle can be effectively maintained. As a result, even after repeated display operations, it becomes possible to effectively prevent reduction in contrast between an image portion and a non-image portion. In a case where the inorganic fine particles having the same constituent materials are not adhered to the positively chargeable display particles and the negatively chargeable display particles, when, during repeated displaying operations, the adhered inorganic fine particle is moved between a base particle of the positively chargeable display particle and a base particle of the negatively chargeable display particle, the balance between charging and physical adhesive strength of the two particles is upset, resulting in reduction in contrast.

In the following description, of the inorganic fine particles having the same constituent materials, those inorganic fine particles to be adhered to the positively chargeable display particles are referred to as inorganic particles A, and those inorganic fine particles to be adhered to the negatively chargeable display particles are referred to as inorganic particles B, and the following description will discuss a case where one kind of inorganic fine particles A is allowed to adhere to the positively chargeable display particles, while one kind of inorganic fine particles B is allowed to adhere to the negatively chargeable display particles, as the inorganic fine particles having the same constituent materials. However, in the present invention, another kind of inorganic particles having the same constituent materials may be further allowed to adhere thereto. Of another kind of inorganic particles having the same constituent materials, the relationship between those inorganic particles to be adhered to the positively chargeable display particles and those inorganic particles to be adhered to the negatively chargeable display particles is the same as the relationship between the inorganic fine particles A and the inorganic fine particles B that would be described later. Additionally, in a case where another kind of inorganic fine particles having the same constituent materials is further allowed to adhere, in addition to the inorganic fine particles A and B, the content rate of the corresponding inorganic fine particles is preferably 15 parts by weight or less, more preferably 5 parts by weight or less, relative to 100 parts by weight of the base particles, in any of the positively chargeable display particles and the negatively chargeable display particles.

The inorganic fine particles A and the inorganic fine particles B are composed of the same constituent materials.

Both of the inorganic fine particles A and B may have a surface treated structure in which the core particle surface is surface-treated by a surface treating agent, or a surface-treatment-free structure made of core particles that are not surface-treated. The inorganic fine particles A and B may have either one of the above-mentioned structures; however, it is defined that the inorganic fine particles A and the inorganic fine particles B have the same structure. That is, an embodiment in which both of the inorganic fine particles A and B have the surface-treated structure and an embodiment in which both of the inorganic fine particles A and B have the surface-treatment-free structure are proposed. In a case where one of the inorganic fine particles A and B has the surface-treated structure while the other has the surface-treatment free structure, during endurance operations, the balance between charging and physical adhesive strength is upset resulting in reduction in contrast.

For example, in a case where the inorganic fine particles A and B have the surface treated structure, the inorganic fine particles A and the inorganic fine particles B are inorganic fine particles having the same core particle constituent material and the same surface treating agent, and preferably the same inorganic fine particles manufactured by the same manufacturing method and the same production conditions, and are more preferably derived from the same manufacturing lot manufactured by the same manufacturing method and the same production conditions.

For example, in a case where the inorganic fine particles A and B have the surface-treatment-free structure, the inorganic fine particles A and the inorganic fine particles B are inorganic fine particles having the same core particle constituent material, and preferably the same inorganic fine particles manufactured by the same manufacturing method and the same production conditions, and are more preferably derived from the same manufacturing lot manufactured by the same manufacturing method and the same production conditions.

In either of the cases, the expression that the core particle constituent material is the same means that, when the material constituting the core particles is represented by a chemical composition formula, it can be represented by the same chemical composition formula, and as long as represented by the same chemical composition formula, the crystal structures may be different from each other. In a case where the core particle constituent material is made of a mixed crystal (mixture of two or more kinds of substances), the main components of the constituent materials may be the same in amounts of substance. For example, since both of anatase-type titanium oxide and rutile-type titanium oxide can be represented by TiO₂, the core particle constituent materials are the same in a case where one of the core particle is anatase-type titanium oxide and the other core particle is rutile-type titanium oxide. When the core particle constituent materials of the inorganic fine particles A and B are not the same, the balance between charging and physical adhesive strength is upset during endurance operations, resulting in reduction in contrast.

The same core particle constituent materials are preferably designed to have the same manufacturing method and the same manufacturing conditions, and more preferably to be derived from the same production lot.

As the core particle constituent material, those materials that have been conventionally used as external additives in the field of display particles and toners for electrostatic latent image development can be used, and for example, silica, titanium oxide, or aluminum oxide can be used. More specifically, as titanium oxide, crystal structures, such as anatase type, rutile type and brookite-type, are exemplified, and since anatase-type and rutile type are indicated by the same chemical composition formula, these are the same. For example, since titanium oxide and barium titanate are not indicated by the same chemical composition formula, these are different. For example, silica is exemplified by crystal structures, such as quartz, cristobalite and tridymite, and since these are only different in their crystal structures, and indicated by the same chemical composition formula, these are the same. For example, aluminum oxide is exemplified by crystal structures such as α-alumina and γ-alumina, and since these are only different in their crystal structures, and indicated by the same chemical composition formula, these are the same.

The expression that the surface treatment agents are the same means that, when the corresponding surface treatment agents are represented by chemical structural formulas, the same chemical structural formula can be used. When the surface treatment agents of the inorganic fine particles A and B are not the same, the charging balance and the balance of physical adhesive strength are upset during endurance operations, resulting in reduction in contrast.

The same surface treatment agents are preferably designed to have the same manufacturing method and the same manufacturing conditions, and more preferably to be derived from the same production lot.

As the surface treatment agent, those surface treatment agents that have been conventionally used as surface treatment agents in the field of display particles and toners for electrostatic latent image development, may be used, and examples thereof include: silicone oil, alkyl halogeno silane, alkylalkoxysilane, a silane coupling agent and alkyl disilazane. Specific examples of the silicone oil include dimethylsilicone oil, methylphenyl silicone oil, methylhydrogen silicone oil. Examples of the alkyl halogeno silane include methyltrichlorosilane, methyldichlorosilane, dimethyldichlorosilane, trimethylchlorosilane, phenyltrichlorosilane, diphenyldichlorosilane and trifluoropropyl trichlorosilane. Examples of the alkylalkoxysilane include methyltrimethoxysilane, methyltriethoxysilane, dimethyldimethoxysilane, dimethyldiethoxysilane, phenyltrimethoxysilane, phenyltriethoxysilane, diphenyldimethoxysilane, diphenyldiethoxysilane, n-propyltrimethoxysilane, n-propyltriethoxysilane, isopropyltrimethoxysilane, isopropyltrimethoxysilane, n-butyltrimethoxysilane, n-butyltriethoxysilane, isobutyltrimethoxysilane, isobutyltrimethoxysilane, hexyltrimethoxysilane, hexyltriethoxysilane, decyltrimethoxysilane, decyltriethoxysilane and trifluoropropyl trimethoxysilane. Examples of the silane coupling agent include amine-based coupling agents, such as N-2-(aminoethyl)-3-aminopropyl trimethoxysilane, N-2-(aminoethyl)-3-aminopropyl triethoxysilane, 3-aminopropyl trimethoxysilane and 3-aminopropyl triethoxysilane, or acryl-based coupling agents, such as 3-methacryloxypropyl trimethoxysilane and 3-methacryloxypropyl triethoxysilane. Examples of the alkyl disilazane include hexamethyldisilazane and hexaethyldisilazane.

In a case where the inorganic fine particles A and B have the surface-treated structure, the degree of hydrophobicity of the inorganic fine particles A and B is preferably 20% or more, more preferably 40% or more. The ratio Sa/Sb between the degree of hydrophobicity Sa of the inorganic fine particles A and the degree of hydrophobicity Sb of the inorganic fine particles B is preferably 0.5 to 2.0, more preferably 0.8 to 1.2, most preferably 1, from the viewpoint of further improving contrast durability.

A value measured based upon methanol wettability is used as the degree of hydrophobicity. The methanol wettability refers to a factor used for evaluating the wettability to methanol. This method uses processes in which 0.2 g of inorganic fine particles to be measured are precisely weighed and added to 50 ml of distilled water put into a beaker having an inner capacity of 200 ml. Methanol is slowly dropped from a burette, with its tip being immersed in the solution, while being slowly stirred, until the entire inorganic fine particles have become wet. Supposing that the amount of methanol required for allowing half the amount (0.1 g) of the inorganic fine particles to become wet with the solvent is set to a (ml), the degree of hydrophobicity is calculated from the following expression:

Degree of hydrophobicity={a/(a+50)}×100.

The surface treatment is achieved by processes in which predetermined core particles are dispersed in a solution of a surface treating agent diluted by a solvent such as methanol, and allowed to react by carrying out a stirring process at a predetermined temperature, and the solvent is then removed. The amount of use of the surface treating agent may be set to such an amount as to sufficiently achieve the above-mentioned degree of hydrophobicity.

From the viewpoint of further improving contrast durability, the inorganic fine particles A and the inorganic fine particles B are preferably designed to have not only the same constituent materials, but also virtually the same average primary particle size, in particular, the same primary particle size. More preferably, from the viewpoint of further improving contrast durability, the average primary particle size ra (nm) of the inorganic fine particles A and the average primary particle size rb (nm) of the inorganic fine particles B are preferably designed to satisfy all the following relational expressions (1) to (3).

5≦ra≦300, preferably 10≦ra≦50; Expression (1)

5≦rb≦300, preferably 10≦rb≦50; and Expression (2)

0.8≦ra/rb≦1.25, preferably 0.9≦ra/rb≦1.1, most preferably ra/rb=1. Expression (3)

In a case where ra and/or rb are too large, since the corresponding fine particles are hardly allowed to adhere to the surfaces of base particles, the contrast is lowered from its initial stage. In a case where ra and/or rb are too small, since the corresponding fine particles are embedded into the surfaces of base particles, the contrast is lowered from its initial stage.

In a case where ra/rb becomes too large, or too small, since the inorganic fine particles A and the inorganic fine particles B become different in their frictional chargeability and physical adhesive strength, the charging balance is upset during endurance operations, resulting in reduction in contrast.

The quantity of charge Cx (μC/g) of the base particles of the positively chargeable display particles, the quantity of charge Cy (μC/g) of the base particles of the negatively chargeable display particles, the quantity of charge Cza (μC/g) of the inorganic fine particles A and the quantity of charge Czb (μC/g) of the inorganic fine particles B are preferably designed to satisfy the following relational expressions:

Cy<Cza<Cx; and

Cy<Czb<Cx,

where Cza/Czb is normally 0.6 to 1.7, preferably 0.8 to 1.25, most preferably 1.

In the present specification, the quantity of charge of particles is represented by a quantity of charge measured based upon an iron powder carrier. More specifically, 2 parts by weight of base particles or particles such as inorganic fine particles serving as a sample and 100 parts by weight of a reference iron powder carrier (Z150/250; made by Powdertech Co., Ltd.) are mixed with each other by a shaker (YS-LD, made by Yayoi Co., Ltd.) for 20 minutes. Thereafter, the quantity of charge of the sample can be measured by using a charge quantity-measuring device (blow-off type TB-200, made by Toshiba Corporation).

The quantity of charge of base particles can be controlled by internally adding a charge-controlling agent to the base particles, which will be described later, or by externally adding fine particles that have been subjected to a surface treatment so as to be fixed thereon. For example, when Nigrosine, which is a positively charging type charge-controlling agent, is added to the inside of the base particles, the quantity of charge of the base particles exhibits a positive value, and the absolute value thereof becomes greater. For example, when a chromium complex, which is a negatively charging type charge-controlling agent, is added to the inside of the base particles, the quantity of charge of the base particles exhibits a negative value, and the absolute value thereof becomes greater.

The quantities of charge of the inorganic fine particles A and B can be controlled by adjusting the kind of a surface-treating agent and the treatment amount thereof. For example, in a case where the treatment is carried out by using an amine-based silane coupling agent, the inorganic fine particles A and B become easily chargeable positively.

The absolute value of the quantity of charge of the inorganic fine particles A and B can also be controlled by adjusting the particle size thereof. For example, in a case where the particle size of inorganic fine particles is made smaller, since the frequency of contact to the other inorganic fine particles increases, the absolute value of the quantity of charge becomes greater. In a case where the particle size of inorganic fine particle is made larger, since the frequency of contact to the other inorganic fine particles decreases, the absolute value of the quantity of charge becomes smaller.

The total content of the inorganic fine particles A and B is preferably 0.01 to 30 parts by weight, more preferably 0.1 to 10 parts by weight, relative to 100 parts by weight of the total amount of the base particles of the positively chargeable display particles and the base particles of the negatively chargeable display particles, from the viewpoint of further improving contrast durability.

In particular, the content Da of the inorganic fine particles A is normally 0.01 to 30 parts by weight, Preferably 0.1 to 10 parts by weight, relative to 100 parts by weight of the base particles of the positively chargeable display particles.

The content Db of the inorganic fine particles B is normally 0.01 to 30 parts by weight, preferably 0.1 to 10 parts by weight, relative to 100 parts by weight of the base particles of the negatively chargeable display particles.

From the viewpoint of further improving contrast durability, Da/Db is in a range from 0.5 to 2.0, more preferably 0.8 to 1.25, most preferably 1.

In the present specification, “to adhere” is used as a concept indicating that the inorganic particles are simply allowed to be attracted to base particles. Through the adherence, the inorganic fine particles are made in contact with the base particles and held on the surfaces of the base particles through a comparatively weak bonding force, and these are separated therefrom comparatively easily by an external force such as mixing. The inorganic fine particles that adhere to the surfaces of the base particles are separated therefrom, when ultrasonic wave energy of 100 μA is applied to the display particles in an aqueous solution of polyoxyethylphenyl ether for one minute.

Such an adherence can be achieved by a mixing process in the following method, and as a result, positively chargeable display particles and negatively chargeable display particles are manufactured.

For example, by using a mixing device, such as a turbular mixer (made by Glen Mills Inc.) and a Henschel mixer (made by Mitsu-Miike Machinery Co., Ltd.), that can carry out a mixing process uniformly by use of a comparatively weak stirring force, the base particles and the inorganic particles A or the inorganic fine particles B are mixed by a comparatively small stirring velocity for a comparatively short mixing period of time.

Of the above-mentioned mixing devices, in particular, the turbular mixer (made by Glen Mills Inc.), which achieves a mixing process by using beads, allows the inorganic fine particles to uniformly adhere to base particles in the form of primary particles, while crushing aggregates of the inorganic fine particles by the beads.

More specifically, for example, in the case of using the turbular mixer (made by Glen Mills Inc.), the stirring velocity is set from 40 to 150 rpm, preferably from 60 to 100 rpm, the mixing time is set from 1 to 10 minutes, preferably from 3 to 7 minutes, and the average particle size of the beads is set from 0.1 to 5 mm, preferably from 0.5 to 3 mm. In a case where the stirring velocity is too high, or the mixing time is too long, or the average particle size of the beads is too small, since the inorganic fine particles to be adhered are fixed, the particle flowability deteriorates, resulting in degradation in driving performance from the initial state. In a case where the stirring velocity is too low, or the mixing time is too short, or the average particle size of the beads is too large, since a uniform mixing process is not carried out, there is degradation in driving performance from the initial state.

For example, in the case of using a Henschel mixer (made by Mitsui-Miike Machinery Co., Ltd.), the stirring velocity is set from 10 to 40 m/sec, preferably from 15 to 30 m/sec, and the mixing time is set from 3 to 30 minutes, preferably from 5 to 15 minutes. In a case where the stirring velocity is too high, or the mixing time is too long, since the inorganic fine particles to be adhered are fixed, the particle flowability, resulting in degradation in driving performance from the initial state. In a case where the stirring velocity is too low, or the mixing time is too short, since a uniform mixing process is not carried out, there is degradation in driving performance from the initial state.

In the present invention, the above-mentioned conditions, such as the core particle constituent material, the surface treating agent, the degree of hydrophobicity, the average primary particle size, the quantity of charge and the content with respect to the inorganic particles A and B may be achieved at any of points of time during the manufacturing processes of the positively chargeable display particles, or the manufacturing processes of the negatively chargeable display particles, or the manufacturing processes of the image display apparatus in accordance with the present invention. The display particles and the image display apparatus that satisfy the above-mentioned conditions at such any of points of time allow the positively chargeable display particles and the negatively chargeable display particles to satisfy the above-mentioned conditions even after separated and collected from the corresponding apparatus.

The positively chargeable display particles and the negatively chargeable display particles can be separated and collected by using the following method. For example, a DC voltage of 500 V is applied between the upper and lower electrodes of an image display apparatus so that the positively chargeable display particles and the negatively chargeable display particles are separated from each other in the apparatus. The DC voltage is applied in such a manner that +500 V is applied to one of the electrodes, while 0 V is applied to the other electrode. Next, the corresponding apparatus is disassembled and positively chargeable display particles are obtained from the minus electrode side, while negatively chargeable display particles are obtained from the plus electrode side.

The inorganic fine particles A can be separated and collected from the positively chargeable display particles by using the following method.

That is, 20 g of display particles are put into a 300-cc beaker, and mixed with 200 g of a 0.2% aqueous solution of polyoxyethylphenyl ether so as to sufficiently become wet. Next, by using an ultrasonic-type homogenizer US-1200T (made by Nippon Seiki Co., Ltd.: specification frequency: 15 kHz), ultrasonic energy is adjusted so that the value of an ampere meter indicating an oscillation indication value, attached to the main body of the device, exhibits 100 μA, and by applying the ultrasonic energy for one minute, the inorganic fine particles are liberated from the base particles. Thereafter, the mixed solution is sucked and filtered through a paper filter having a pore size of 1 μm so that a filtrate containing the inorganic fine particles A can be obtained. By removing solvent from the filtrate, the inorganic fine particles A can be obtained in a powder form.

The separation and extraction of the inorganic particles B from the negatively chargeable display particles are achieved by using the same method as the above-mentioned separating and extracting method for the inorganic fine particles A from the positively chargeable display particles.

After the inorganic fine particles have been separated and collected by the above-mentioned methods, a determination as to whether or not the inorganic fine particles A and the inorganic fine particles B are identical to each other is carried out by identifying the core material and the surface treating agent through an infrared spectroscopic analysis and a fluorescent X-ray analysis. The primary particle size can be measured by using a scanning electron microscope.

In the present invention, in addition to the inorganic fine particles having the same constituent materials, two kinds of inorganic fine particles whose constituent materials are different from each other are used, and one of those may be adhered to positively chargeable display particles, while the other of those may be adhered to negatively chargeable display particles. In this case, the content of the inorganic fine particles A in the positively chargeable display particles is preferably 60 wt % or more, particularly preferably 80 wt % or more, relative to the entire adhered inorganic fine particles in the positively chargeable display particles. The content of the inorganic fine particles B in the negatively chargeable display particles is preferably 60 wt % or more, particularly preferably 80 wt % or more, relative to the entire adhered inorganic fine particles in the negatively chargeable display particles.

The total content of the inorganic fine particles A and the inorganic fine particles B is preferably 60 wt % or more, particularly preferably 80 wt % or more, relative to the entire adhering inorganic fine particles in the positively chargeable display particles and the negatively chargeable display particles.

As the inorganic fine particles whose constituent materials are different from each other, inorganic fine particles made of the same material as that of the core particle constituent material and inorganic fine particles formed by subjecting the inorganic fine particles to a surface treatment by using the above-mentioned surface treating agent are proposed. The average primary particle sizes of the inorganic fine particles whose constituent materials are different from each other are not particularly limited, but may be respectively 5 to 300 nm, particularly 10 to 50 nm.

The base particles forming the positively chargeable display particles and the negatively chargeable display particles contain at least a binder resin and a colorant.

The binder resin constituting the base particles of the positively chargeable display particles and the negatively chargeable display particles is not particularly limited, but may be constituted by using typically a polymer referred to as a vinyl-based resin shown below, and in addition to the vinyl-based resins, condensation-type resins such as polyamide resins, polyester resins, polycarbonate resins and epoxy resins may be used. Specific examples of the vinyl-based resins include: in addition to polystyrene resins, polyacrylic resins and polymethacrylic resins, polyolefin resins or the like formed by an ethylene monomer and a propylene monomer. As the resins other than the vinyl-based resins, in addition to the above-mentioned condensation-type resins, polyether resins, polysulfone resins, polyurethane resins, fluorine-based resins, silicone resins and the like are listed.

As the polymer for forming the binder resin used for forming the base particles, in addition to those obtained by using at least one kind of polymerizable monomers forming these resins, a plurality of kinds of polymerizable monomers may be combined to form the polymer. Upon forming a resin by using a plurality of kinds of polymerizable monomers in combination, in addition to methods in which a copolymer, such as a block copolymer, a graft copolymer and a random copolymer, is formed, a polymer blending method in which a plurality of kinds of resins are mixed with one another may be used. As the copolymer, for example, a styrene-acrylic resin is preferably used.

As the colorant to be contained in the base particles, it is not particularly limited as long as colorants having different colors between one used for the positively chargeable display particles and the other used for the negatively chargeable display particles, and known pigments may be used. The following description will explain white base particles and black base particles; however, the present invention should not be construed by being limited to these combinations.

Specific examples of the white pigment forming the white base particles include anatase-type titanium oxide, rutile-type titanium oxide, zinc oxide (zinc white), antimony white and zinc sulfide. From the viewpoint of improving the white density of the particles, anatase-type titanium oxide, rutile-type titanium oxide and zinc oxide are preferably used, and in particular, anatase-type titanium oxide and rutile-type titanium oxide are more preferably used. Two or more kinds of white pigments may be combined and contained. In particular, the application of titanium oxide as the colorant is effective from the viewpoint of charging polarity, because the base particles of the positively chargeable display particles can be manufactured without using a charge-controlling agent or the like.

Specific examples of a black pigment for forming black base particles include: carbon black, copper oxide, manganese dioxide, aniline black, activated carbon and the like. Froth the viewpoint of obtaining the degree of black color by adding a small amount, carbon black is preferably used. Two or more black pigments may be combined and contained.

From the viewpoint of balance between reduction in driving voltage and improvement of contrast, the content of the colorant is normally 20 to 200 parts by weight, particularly 50 to 150 parts by weight, in the case of the white base particles, and it is normally 2 to 20 parts by weight, particularly 4 to 10 parts by weight, in the case of the black base particles, relative to 100 parts by weight of the binder resin.

The average primary particle size of the colorant is not particularly limited as long as coloring strength is exerted, and it is normally 50 to 500 nm, particularly 100 to 300 nm, in the case of the white pigment, and it is normally 10 to 50 nm, particularly 15 to 35 nm, in the case of the black pigment.

In the present specification, a value measured by the following method is used as the average primary particle size.

A photograph is taken by a scanning electron microscope (generally referred to as SEM) in a magnification of 10,000 times, and an average value of 100 particles in the actual image is used.

As a method for manufacturing the base particles, it is not particularly limited, and known methods for manufacturing particles containing a resin and a colorant, such as a method for manufacturing a toner to be used for image formation in an electrophotographic system, may be adopted and used. As a specific method for manufacturing the base particles, for example, the following methods may be used.

(1) After kneading a resin and a colorant, the resulting matter is subjected to respective pulverizing and classifying processes so that base particles are formed;
(2) A polymerizable monomer and a colorant are mechanically stirred in an aqueous medium to form droplets, and these are then subjected to a polymerizing process to form base particles, which is a so-called suspension polymerization method; and
(3) A polymerizable monomer is dropped into an aqueous medium in which a surfactant is contained, and after the mixture has been subjected to a polymerizing reaction in a micelle so that polymer particles in the range of 100 to 150 nm are formed, and after adding colorant particles and a coagulating agent thereto, these particles are then associated with one another so that base particles are manufactured, which is a so-called emulsion association method.

Another additive, for example, a charge-controlling agent may be contained in the base particles; however, from the viewpoint of further improving contrast durability, it is preferable not to contain the charge-controlling agent.

From the viewpoint of reducing a driving voltage, the base particles preferably have inorganic fine particles fixed on the surfaces thereof; however, in the case of using the base particles on which the inorganic fine particles have been fixed, such base particles are used for both of the positively chargeable display particles and the negatively chargeable display particles. In a case where the base particles on which the inorganic fine particles have been fixed are used only for the one thereof, while the base particles having no inorganic fine particles fixed thereon are used for the other, adhesive properties between the adhered inorganic fine particles and the base particles become different between the black and white particles during endurance operations, with the result that the charging balance is upset to cause reduction in contrast.

The fixed state is used as a concept indicating that at least one portion of an inorganic fine particle is embedded into the base particle, with the inorganic fine particles being brought into an immovable state on the surfaces of the base particles. By the fixed state, the inorganic fine particles are maintained on the base particle surfaces through a comparatively strong bonding force, and are not easily separated therefrom by an external force such as mixing. The inorganic fine particles that have been fixed on the surfaces of the base particles are not liberated when, for example, ultrasonic energy of 100 μA is applied to the display particles for one minute in an aqueous solution of polyoxyethylphenyl ether; however, when ultrasonic energy of 300 μA is applied thereto for 60 minutes, they are liberated.

Such a fixed state is achieved by carrying out a mixing process using the following method.

For example, by using a mixing device, such as a Henschel mixer (made by Mitui-Miike Machinery Co., Ltd.), a Hybridizer (made by Nara Machinery Co., Ltd.), a Super Mixer (made by Kawata MFG Co., Ltd.), capable of mixing uniformly by a comparatively high stirring force, the base particles and the inorganic fine particles to be fixed are mixed at a comparatively high stirring velocity and a comparatively long mixing time.

More specifically, for example, in the case of using a Henschel mixer (made by Mitsui-Miike Machinery Co., Ltd.), the stirring velocity is set from 50 to 80 m/sec, preferably from 55 to 70 m/s, and the mixing time is set from 20 to 90 minutes, preferably from 30 to 60 minutes. In a case where the stirring velocity is too high, or the mixing time is too long, since cracks occur in the base particles, contrast durability is lowered. In a case where the stirring velocity is too low, or the mixing time is too short, since a sufficient anchoring process is not achieved, inorganic fine particles to be fixed remain as adhered particles, resulting in reduction in contrast durability.

The content of inorganic fine particles to be fixed in the positively chargeable display particles and the negatively chargeable display particles respectively is preferably 20 parts by weight or less, particularly 0.1 to 10 parts by weight, relative to 100 parts by weight of the base particles. When the content is too high, those inorganic fine particles to be fixed are not completely fixed, with the result that contrast durability is lowered.

In the positively chargeable display particles and the negatively chargeable display particles, the total content of the inorganic fine particles to be fixed is 20 parts by weight or less, particularly 0.1 to 10 parts by weight, relative to 100 parts by weight of the entire base particles for the positively chargeable display particles and the negatively chargeable display particles.

As those inorganic fine particles to be fixed on the positively chargeable display particles and those inorganic fine particles to be fixed on the negatively chargeable display particles, inorganic fine particles having the same inorganic fine particle constituent materials, such as a core particle constituent material and a surface treating agent, are used. Preferably, inorganic fine particles also having the same average primary particle size are used.

The inorganic fine particles to be fixed may have a surface treated structure in which the core particle surface is surface-treated by a surface treating agent, a surface treatment-free structure made of core particles that are not surface-treated.

As the core particle constituent materials for the inorganic fine particles to be fixed, for example, the same materials as those of the constituent materials for the inorganic fine particles A and B to be adhered are proposed.

As the surface treating agent for the inorganic fine particles to be fixed, for example, the same material as the surface treating agent for the inorganic fine particles A and B to be adhered is proposed.

The average primary particle size Ra (nm) of the inorganic fine particles to be fixed on the positively chargeable display particles and the average primary particle size Rb (nm) of the inorganic fine particles to be fixed on the negatively chargeable display particles are preferably designed to satisfy all the following relational expressions (4) to (6) from the viewpoint of further improving contrast durability.

10≦Ra≦500, preferably 20≦Ra≦100; Expression (4)

10≦Rb≦500, preferably 20≦Rb≦100; and Expression (5)

0.4≦Ra/Rb≦2.0, preferably 0.6≦Ra/Rb≦1.7, most preferably Ra/Rb=1. Expression (6)

The relationship of the degree of hydrophobicity or the like between those inorganic fine particles to be fixed onto the positively chargeable display particles and those inorganic fine particles to be fixed on the negatively chargeable display particles may be the same as the relationship of the degree of hydrophobicity between the inorganic fine particles A and the inorganic fine particles B.

In the present invention, the above-mentioned conditions, such as the core particle constituent material, the surface treating agent, the degree of hydrophobicity, the average primary particle size and the content with respect to the inorganic particles to be fixed may be achieved at any of points of time during the manufacturing processes of the image display apparatus in accordance with the present invention. The display particles and the image display apparatus that satisfy the above-mentioned conditions at such any of points of time allow the positively chargeable display particles and the negatively chargeable display particles to satisfy the above-mentioned conditions even after separated and collected from the corresponding apparatus.

The fixed inorganic fine particles can be separated and collected from the positively chargeable display particles or the negatively chargeable display particles by using the following method.

Specifically, 20 g of display particles are put into a 300-cc beaker, and mixed with 200 g of a 0.2% aqueous solution of polyoxyethylphenyl ether so as to sufficiently become wet. Then, by using an ultrasonic-type homogenizer US-1200T (made by Nippon Seiki Co., Ltd.: specification frequency: 15 kHz), ultrasonic energy is adjusted so that the value of an ampere meter indicating an oscillation indication value attached to the main body device exhibits 100 μA, and by applying the ultrasonic energy for one minute, the adhered inorganic fine particles are separated from the base particles, and the mixed solution is sucked and filtered through a paper filter having a pore size of 1 μm so that the adhered particles can be separated into a filtrate. Thereafter, the particles remaining on the filter paper are re-dispersed in an aqueous solution of polyoxyethylphenyl ether, and ultrasonic energy is adjusted so that the value of an ampere meter indicating an oscillation indication value attached to the main body device exhibits 300 μA, and by applying this for 60 minutes, the fixed inorganic fine particles are separated from the base particles. The mixed solution is sucked and filtered through a paper filter having a pore size of 1 μm so that a filtrate containing the inorganic fine particles can be obtained. By removing solvent from the filtrate, the inorganic fine particles in a powder form can be obtained.

The volume-average particle size D1 of the positively chargeable display particles and the volume-average particle size D2 of the negatively chargeable display particles are 0.1 to 50 μm, preferably 1 to 20 μm from the viewpoints of reduction in driving voltage, high contrast and high image quality.

Volume average particle sizes D1 and D2 of the particles corresponds to a volume reference median diameter (d50 diameter), and can be measured and calculated by using a device in which a Multisizer 3 (made by Beckman Coulter, Inc.) is connected to a computer system for use in data processing.

The measuring sequence includes processes in which, after particles (0.02 g) has been added 20 ml of a surfactant solution (used for dispersing particles, and obtained by diluting a neutral detergent containing a surfactant component with pure water ten times as much), the resulting solution is subjected to an ultrasonic dispersing process for 1 minute so that a particle dispersion solution is prepared. This particle dispersion solution is poured into a beaker containing ISOTON II (made by Beckman Coulter, Inc.) inside a sample stand by using a pipet until it has reached a measured concentration of 10%, and by setting a measuring machine count to 2500 pieces, a measuring process is carried out. The Multisizer 3 having an aperture diameter of 50 μm is used.

The display particles of the present invention are prepared by using processes in which predetermined inorganic fine particles are adhered/fixed by using the above-mentioned method so that the positively chargeable display particles and the negatively chargeable display particles are independently prepared, and these particles are then sealed in an image display apparatus during its manufacturing processes so that they are used in the corresponding apparatus.

Image Display Apparatus

The image display apparatus in accordance with the present invention is characterized by being provided with the above-mentioned display particles. The following description will explain the image display apparatus of the present invention in detail.

In the image display apparatus relating to the present invention, the above-mentioned display particles are sealed between two substrates at least one of which is transparent, and by generating an electric field between the substrates, the display particles are moved in a gaseous phase so that an image is displayed.

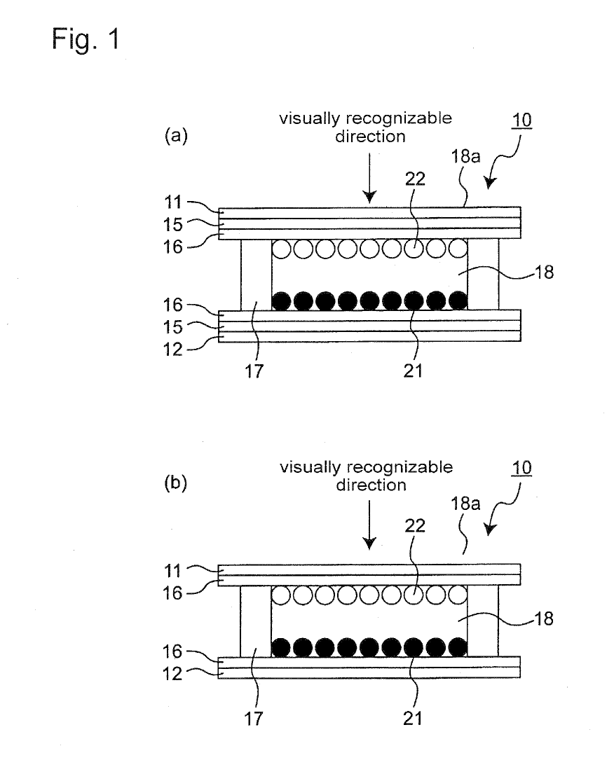

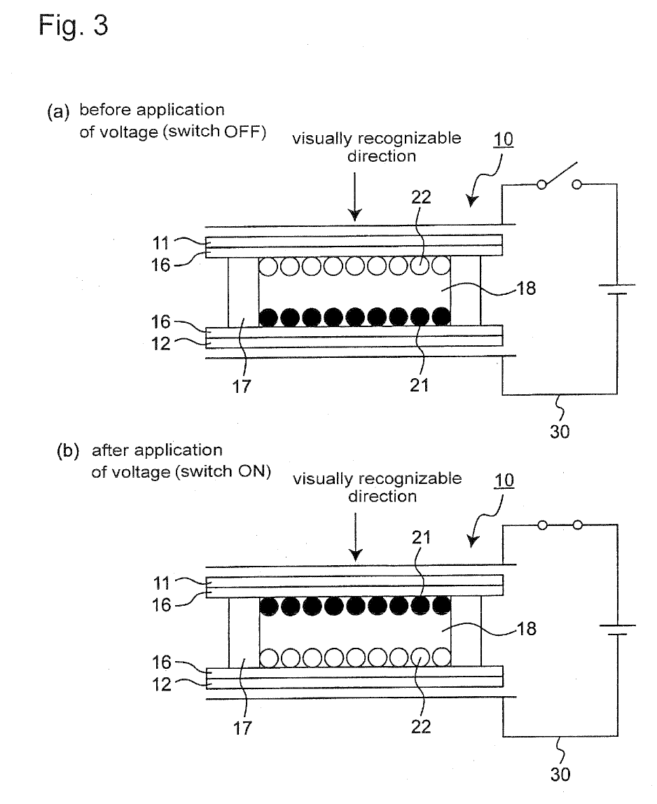

FIG. 1 shows a typical cross-sectional structure of the image display apparatus in accordance with the present invention. FIG. 1(a) shows a structure in which an electrode 15 having a layer structure is formed on each of substrates 11, 12, and an insulating layer 16 is formed on the surface of the electrode 15. The image display apparatus shown in FIG. 1(b) has a structure in which no electrode is provided in the apparatus, and is designed so that an electric field is applied by electrodes provided on the outside of the apparatus so as to move the display particles. In FIG. 1(a) and FIG. 1(b), the same reference numerals represent the same members. FIG. 1 indicates FIG. 1(a) and FIG. 1(b) in a manner to be included therein. An image display apparatus 10 in FIG. 1 is supposed to be used for viewing images from the substrate 11 side as shown in the figure; however, the present invention is not intended to be limited by the structure in which images are viewed from the substrate 11 side. Since no electrode 15 is provided to the apparatus, the apparatus having a type indicated by FIG. 1(b) can be simplified in its apparatus structure and is advantageous in that its manufacturing processes can be shortened. FIG. 3 shows a state in which the image display apparatus 10 of the type shown in FIG. 1(b) is set in a device capable of applying a voltage so that the voltage is applied thereto. The cross-sectional structure of the image display apparatus of the present invention is not intended to be limited by those shown in FIGS. 1(a) and 1(b).

On the outermost portion of the image display apparatus 10 of FIG. 1(a), two substrates 11 and 12 that form a case constituting the image display apparatus are arranged so as to be opposed to each other. An electrode 15 used for applying a voltage is provided on the surface of each of the substrates 11, 12 on the mutually opposed side, and an insulating layer 16 is provided on the electrode 15. The electrode 15 and the insulating layer 16 are provided on each of the substrates 11 and 12, and display particles are present in a gap 18 formed by making the surfaces on the side having the electrode 15 and the insulating layer 16 face to face with each other. In the image display apparatus 10 shown in FIG. 1, two kinds of display particles, that is, negatively charged black display particles 21 (hereinafter, referred to as black particles) and positively charged white display particles 22 (hereinafter, referred to as white particles) are present in the gap 18 as display particles. Strictly speaking, the aforementioned external additives are added to the surface of the black particles 21 and the white particles 22 and located thereon; however, these are not shown. The image display apparatus 10 of FIG. 1 has a structure in which the gap 18 is surrounded by the substrates 11 and 12 and two barrier ribs 17 from four sides thereof, and the display particles in a powder form are present in the gap 18 in a sealed state.

The thickness of the gap 18 is not particularly limited as long as it is maintained in such a range that the sealed display particles can be moved and the contrast of an image is properly maintained, and is normally 10 μm to 500 μl, preferably 10 μm to 100 μm. The volume-filling-ratio of the display particles within the gap 18 is 5% to 70%, preferably 30% to 60%. By making the volume-filling-ratio of the display particles within the above-mentioned range, the display particles in the gap 18 are allowed to move smoothly, and it becomes possible to obtain an image with superior contrast.

The following description will discuss behaviors of display particles in the gap 18 of the image display apparatus 10.

In the image display apparatus relating to the present invention, upon application of a voltage between the two substrates so that an electric field is formed therein, charged display particles are allowed to move in the electric field direction. In this manner, by applying a voltage between the substrates where the display particles are present, the charged display particles are allowed to move between the substrates so that an image display is carried out.

The image display in the image display apparatus of the present invention is carried out through the following sequence of processes.

(1) Display particles to be used for display media are charged by using a known method, such as frictional charging with a carrier or the like.
(2) The display particles are sealed between two opposed substrates, and in this state, a voltage is applied between the substrates.
(3) By the voltage application between the substrates, an electric field is formed between the substrates.
(4) The display particles are attracted toward the substrate surfaces in the electric field direction on the side opposite to the polarity of the display particles by a function of a force of the electric field between the electrodes so that an image display is carried out.
(5) By changing the electric field direction between the substrates, the moving directions of the display particles are switched. By switching the moving directions, it is possible to change the image display in various ways.

As a charging method of display particles by the above-mentioned known method, for example, a method is proposed in which display particles are made in contact with a carrier so as to charge the display particles by frictional charging, and another method is proposed in which display particles of two colors having different charging properties are mixed and stirred so that the display particles are charged by frictional charging among the particles, and in the present invention, a carrier is used, and the charged display particles are preferably sealed between substrates.

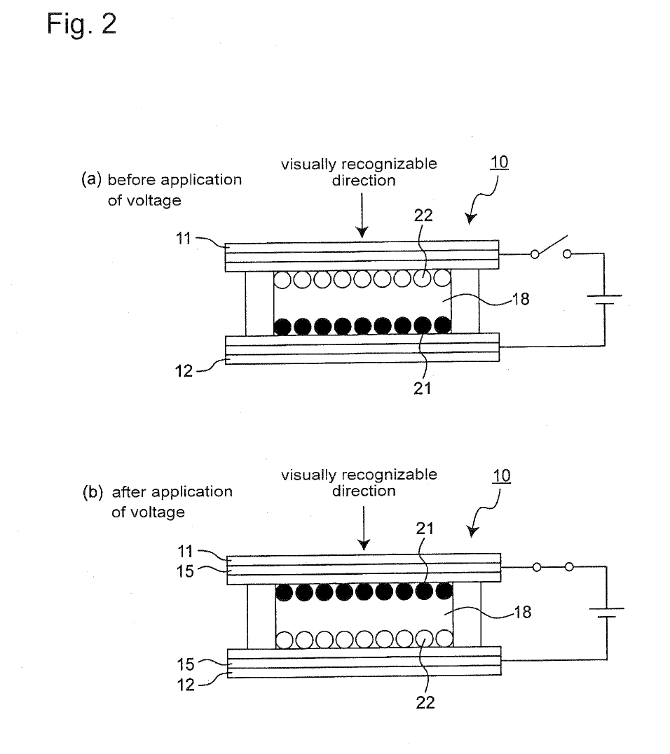

FIGS. 2 and 3 show examples of movements of display particles in response to a voltage application between substrates.

FIG. 2(a) shows a state Prior to a voltage application between substrates 11 and 12, and prior to the voltage application, white particles 22 positively charged are located in the vicinity of the substrate 11 on the visible side. This state shows that an image display apparatus 10 displays a white image. FIG. 2(b) shows a state after the application of voltage to an electrode 15. By applying a positive voltage to

the substrate 11, the black particles 21 negatively charged have been moved in the vicinity of the substrate 11 on the visible side, while the white particles 22 have been moved to the substrate 12 side. In this state, the image display apparatus 10 displays a black image.

FIG. 3 show a structure in which the image display apparatus 10 shown in FIG. 1(b) of a type without electrodes is connected to a voltage application device 30, and also show a state prior to an application of a voltage in this state (FIG. 3(a)) and a state after the application of the voltage (FIG. 3(b)). The image display apparatus 10 of the type shown in FIG. 3(b) is similar to the image display apparatus 10 having the electrode 15 By applying a positive voltage to the substrate 11, the black particles 21 negatively charged have been moved in the vicinity of a substrate 11 on the visible side, while the white particles 22 positively charged have been moved to the substrate 12 side.

The following description will explain substrates 11 and 12, an electrode 15, an insulating layer 16 and barrier ribs 17, that constitute the image display apparatus 10 shown in FIG. 1.

First, the substrates 11 and 12 constituting the image display apparatus 10 will be described. In the image display apparatus 10, since a viewer visually recognizes an image formed by display particles from at least one of the sides of the substrates 11 and 12, the substrate to be provided on the visible side by the viewer needs to be formed by a transparent material. Therefore, the substrate to be used on the image visible side by the viewer is preferably formed by a light-transmitting material having a visible light transmittance of 80% or more, and the visible light transmittance of 80% or more makes it possible to provide sufficient visibility. Of the substrates constituting the image display apparatus 10, the substrate to be placed on the side opposite to the image visible side is not necessarily made from a transparent material.

The thicknesses of the substrates 11 and 12 are preferably 2 μm to 5 mm, more preferably 5 μm to 2 mm, respectively. When the thicknesses of the substrates 11 and 12 are within the above-mentioned range, it is possible to allow the image display apparatus 10 to have sufficient strength and the gap between the substrates can be uniformly maintained. By making the thicknesses of the substrates within the above-mentioned range, a compact, light-weight image display apparatus can be provided so that an application of the image display apparatus can be promoted in a wider field. In addition, by making the thickness of the substrate on the image visible side within the above-mentioned range, it is possible to provide accurate visual recognition of a display image and consequently to prevent problems with display quality.

As the material having a visible light transmittance of 80% or more, examples thereof include an inorganic material, such as glass and quartz, having no flexibility, an organic material typically represented by a resin material, which will be described later, and a metal sheet. Among these, the organic material and the metal sheet allow the image display apparatus to have a certain degree of flexibility. As the resin material capable of providing a visible light transmittance of 80% or more, for example, polyester resins, typically represented by polyethylene terephthalate and polyethylene naphthalate, polycarbonate resins, polyethersulfone resins, polyimide resins and the like may be used. Acrylic resins that are polymers of acrylic acid esters and methacrylic acid esters, typically represented by polymethyl methacrylate (PMMA), and transparent resins obtained by radical-polymerizing a vinyl-based polymerizable monomer such as polyethylene resins, may be used.

The electrodes 15 are provided on the surfaces of the substrates 11 and 12, and used for forming an electric field between the substrates, that is, in the gap 18, by applying a voltage. In the same manner as in the aforementioned substrates, the electrode 15 to be formed on the image visible side to the viewer needs to be formed by using a transparent material.

The thickness of the electrode to be provided on the image visible side needs to be set to such a level as to ensure conductivity and also to avoid problems with light-transmitting property, and more specifically, it is preferably 3 nm to more preferably 5 nm to 400 nm. The visible light transmittance of the electrode to be provided on the image visible side is preferably 80% or more, in the same manner as that of the substrate. The thickness of the electrode to be provided on the side opposite to the image visible side is preferably within the above-mentioned range, but the electrode is not required to be made of a transparent material.

As a constituent material for the electrodes 15, examples thereof include: a metal material and a conductive metal oxide, or a conductive polymer material. Specific examples of the metal material include: aluminum, silver, nickel, copper, gold and the like, and specific examples of the conductive metal oxide include: indium-tin oxide (ITO), indium oxide, antimony-tin oxide (ATO), tin oxide, zinc oxide and the like. Examples of the conductive polymer material include: polyaniline, polypyrrole, polythiophene, polyacetylene, and the like.

As a method for forming the electrode 15 on the substrates 11 and 12, for example, in the case of forming a thin-film electrode, a sputtering method, a vacuum vapor deposition method, a chemical vapor deposition method (CVD method) and a coating method are proposed. Another method may be proposed in which a conductive material is mixed with a solvent and a binder resin and this mixture is applied to a substrate so as to form an electrode.

The insulating layer 16 is provided on the surface of the electrode 15 so that the surface of the insulating layer 16 is made in contact with display particles 21 and 22. The insulating layer 16 has a function for alleviating a change in quantity of charge by using a voltage to be applied upon moving the display particles 21 and 22. By imparting a resin having a structure with high hydrophobicity, or irregularities thereto, it also has a function for reducing a physical adhesive force to display particles and consequently reducing a driving voltage. As a material for constituting the insulating layer 16, a material that has an electrical insulating property, can be formed into a thin film, and also has a transparent property, if necessary, is preferably used. The insulating layer to be formed on the image visible side is preferably designed to have a visible light transmittance of 80% or more in the same manner as in the substrate. Specific examples thereof include: silicone resins, acrylic resins, polycarbonate resins and the like.

The thickness of the insulating layer 16 is preferably 0.01 μm or more to 10.0 μm or less. That is, when the thickness of the insulating layer 16 is within the above-mentioned range, it is possible to move the display particles 21, 22 without a necessity of applying a high voltage between the electrodes 15, and this structure is preferable because, for example, an image display can be carried out by applying a voltage in such a level as to be applied during an image forming process by use of an electrophoretic method.

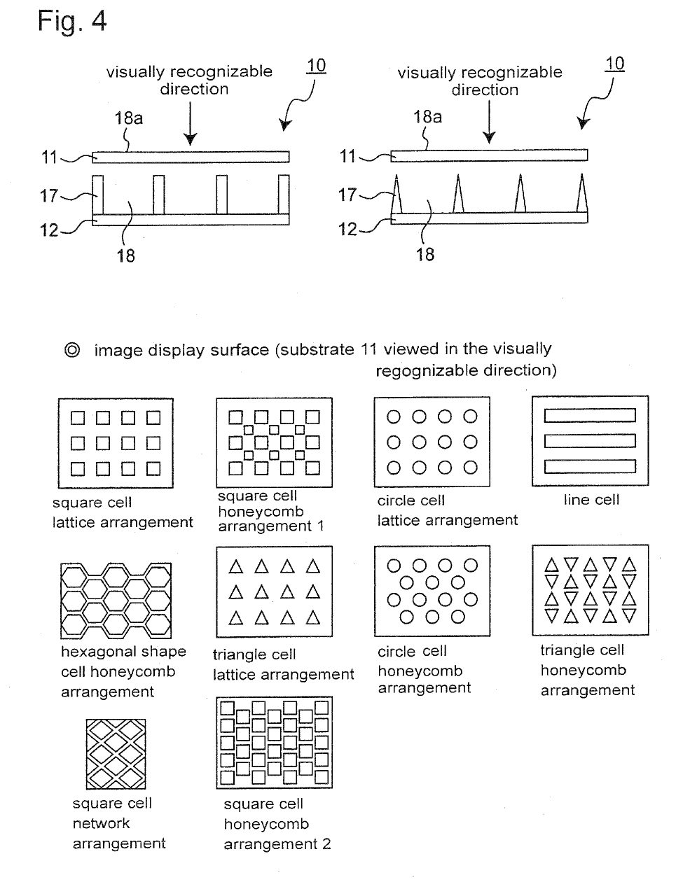

The barrier rib 17 is used for ensuring the gap 18 between the upper and lower substrates, and as shown on the right side and left side in the upper stage of FIG. 4, these may be formed not only on the edge portion of the substrate 11, 12, but also inside thereof, if necessary. The width of the barrier rib 17, in particular, the thickness of the barrier rib on the image display surface 18 side, is preferably made as thin as possible from the viewpoint of ensuring clearness of a display image, as shown on the right side in the upper stage of FIG. 4.

The barrier rib 17 to be formed inside of the substrate 11, 12 may be formed continuously, or may be formed intermittently, in a direction from the surface to rear face, as shown on the right side and left side in the upper stage of FIG. 4.

By controlling the shape and arrangement of the barrier ribs 17, the cell of the gap 18 divided by the barrier ribs 17 can be arranged with a various shape. Examples of the shape and arrangement of the cells at the time when the gap 18 is viewed in the visible direction of the substrate 11 are shown in the lower stage of FIG. 4. As shown in the lower stage of FIG. 4, by using a rectangular shape, a triangular shape, a line shape, a round shape, a hexagonal shape or the like, a plurality of ribs can be arranged into a honeycomb and a network.

The barrier ribs 17 can be formed by carrying out a shaping process on the substrate opposite to the image-recognizing side, for example, by using the following method. As a method for shaping the barrier ribs 17, for example, a method for forming irregularities by using an embossing process and a thermal press injection molding process to be carried out on a resin material or the like, a photolithography method, a screen printing method and the like are proposed.

The image display apparatus in accordance with the present invention can be manufactured by using, for example, an electrophotographic developing system as described below.

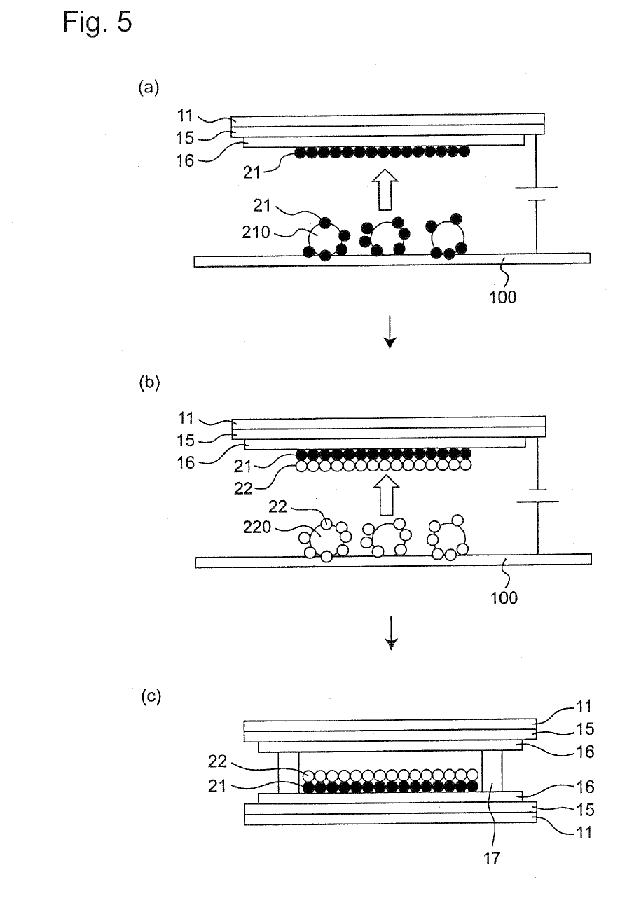

An electrode 15 and an insulating layer 16, if necessary, are formed on each of two substrates 11 and 12 so that a pair of substrates with electrodes formed thereon are obtained. By mixing display particles 21 and a carrier 210, the display particles 21 are negatively charged, and mixtures (21, 210) are placed on a conductive stage 100 as shown in FIG. 5(a), and one of the substrates with electrodes is arranged with a predetermined distance being set from the stage 100. As shown in FIG. 5(a), a DC voltage and an AC voltage having a positive polarity are applied to the electrode 15 so that the negatively chargeable display particles 21 are allowed to adhere onto the insulating layer 16. Next, by mixing display particles 22 and a carrier 220, the display particles 22 are positively charged, and mixtures (22, 220) are placed on the conductive stage 100, as shown in FIG. 5(b), and the substrate with electrodes to which negatively chargeable display particles have been adhered is arranged with a predetermined distance being set from the stage 100. Next, as shown in FIG. 5(b), a DC voltage and an AC voltage having a positive polarity are applied to the electrode 15 so that the positively chargeable display particles 22 are allowed to adhere onto the adhering layer of the negatively chargeable display particles 21. One of the substrate with electrodes to which the negatively chargeable display particles and the positively chargeable display particles have been adhered and the other substrate with electrode are superposed as shown in FIG. 5(c) by adjusting the barrier rib so as to form a predetermined interval, and the peripheral portions of the substrates are bonded so that an image displaying apparatus can be obtained.

The image display apparatus can be manufactured based upon another embodiment of the electrophotographic developing system as described below.

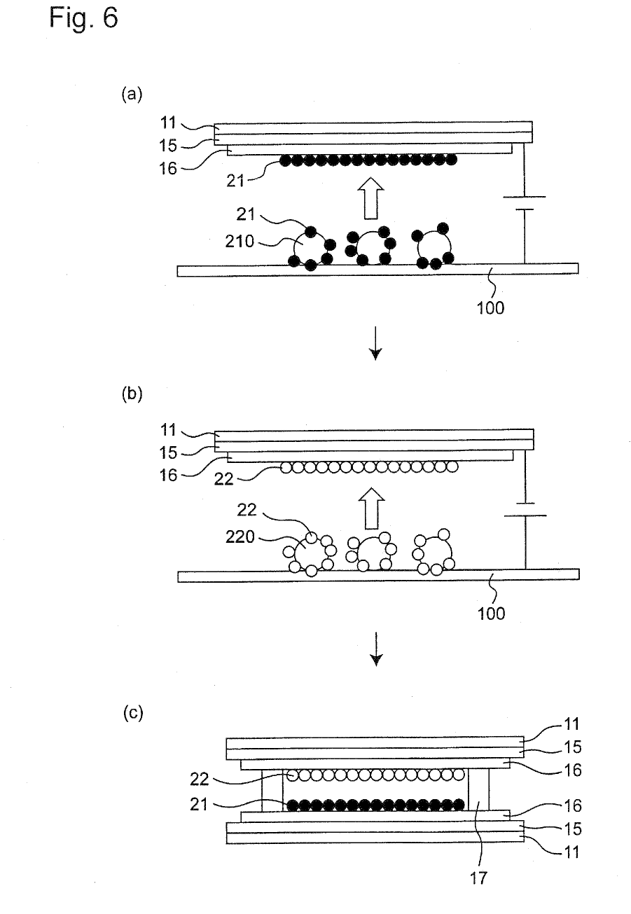

An electrode 15 and an insulating layer 16, if necessary, are formed on each of two substrates 11 and 12 so that a pair of substrates with electrodes formed thereon are obtained. By mixing display particles 21 and a carrier 210, the display particles 21 are negatively charged, and mixtures (21, 210) are placed on conductive stage 100 as shown in FIG. 6(a), and one of the substrates with electrodes is placed with a predetermined distance being set from the stage 100. As shown in FIG. 6(a), a DC voltage and an AC voltage having a positive polarity are applied to the electrode 15 so that the negatively chargeable display particles 21 are allowed to adhere onto the insulating layer 16.

By mixing display particles 22 and a carrier 220, the display particles 22 are positively charged, and mixtures (22, 220) are placed on the conductive stage 100, as shown in FIG. 6(b), and the other substrate with electrode is placed with a predetermined distance being set from the stage 100. As shown in FIG. 6(b), a DC voltage and an AC voltage having a negative polarity are applied to the electrode 15 so that the positively chargeable display particles 22 are allowed to adhere onto the insulating layer 16. The substrate with electrode to which the negatively chargeable display particles have been adhered and the substrate with electrode to which the positively chargeable display particles have been adhered are superposed as shown in FIG. 6(c) by adjusting the barrier rib so as to form a predetermined interval, and the peripheral portions of the substrates are bonded so that an image displaying apparatus can be obtained.

### EXAMPLES

### Production of Inorganic Fine Particles x1

Silica particles (SiO₂) having an average primary particle size of 20 nm that had been subjected to a surface treatment with hexamethyldisilazane were used as inorganic fine particles x1. The quantity of charge and the degree of hydrophobicity thereof were measured by using the aforementioned method.

### Production of Inorganic Fine Particles x2

Titanium oxide particles (TiO₂) having an average primary particle size of 20 nm that had been subjected to a surface treatment with isobutyl trimethoxysilane were used as inorganic fine particles x2. The quantity of charge and the degree of hydrophobicity thereof were measured by using the aforementioned method.

### Production of Inorganic Fine Particles x3

Aluminum oxide particles (Al₂O₃) having an average primary particle size of 20 nm that had been subjected to a surface treatment with n-butyl trimethoxysilane were used as inorganic fine particles x3. The quantity of charge and the degree of hydrophobicity thereof were measured by using the aforementioned method.

### Production of Inorganic Fine Particles x4

Silica particles (SiO₂) having an average primary particle size of 20 nm that had been subjected to a surface treatment with isobutyl trimethoxysilane were used as inorganic fine particles x4. The quantity of charge and the degree of hydrophobicity thereof were measured by using the aforementioned method.

### Production of Inorganic Fine Particles x5

Silica particles (SiO₂) having an average primary particle size of 25 nm that had been subjected to a surface treatment with 3-aminopropyl trimethoxysilane were used as inorganic fine particles x5. The quantity of charge and the degree of hydrophobicity thereof were measured by using the aforementioned method.

### Production of Inorganic Fine Particles x6

Silica particles (SiO₂) having an average primary particle size of 25 nm that had not been subjected to a surface treatment were used as they were as inorganic fine particles x6. The quantity of charge and the degree of hydrophobicity thereof were measured by using the aforementioned method.

### Production of Inorganic Fine Particles y1

Silica particles (SiO₂) having an average primary particle size of 100 nm that had been subjected to a surface treatment with aminopropyl trimethoxysilane were used as inorganic fine particles y1. The quantity of charge and the degree of hydrophobicity thereof were measured by using the aforementioned method.

### Production of Inorganic Fine Particles y2

Silica particles (SiO₂) having an average primary particle size of 100 nm that had been subjected to a surface treatment with hexamethyl disilazane were used as inorganic fine particles y2. The quantity of charge and the degree of hydrophobicity thereof were measured by using the aforementioned method.

TABLE 1

| | | | Degree of |
|---|---|---|---|
| | Average primary | Quantity of charge | hydrophobicity |
| | particle size (nm) | (μC/g) | (%) |
| Inorganic fine | 20 | −50 | 55 |
| particles x1 | | | |
| Inorganic fine | 20 | −10 | 40 |
| particles x2 | | | |
| Inorganic fine | 20 | −20 | 35 |
| particles x3 | | | |
| Inorganic fine | 20 | −45 | 50 |
| particles x4 | | | |
| Inorganic fine | 25 | +25 | 20 |
| particles x5 | | | |
| Inorganic fine | 25 | −40 | 0 |
| particles x6 | | | |
| Inorganic fine | 100 | +20 | 20 |
| particles y1 | | | |
| Inorganic fine | 100 | −40 | 55 |
| particles y2 | | | |

### Production of White Particles A

The following resin and titanium oxide were loaded into a Henschel mixer (made by Mitsui-Miike Machinery Co., Ltd.) and a mixing process was carried out for five minutes, with a peripheral speed of stirring blades being set to 25 m/s, so that a mixture was prepared.

| | |
|---|---|
| Styrene acrylic resin (weight average molecular | 100 parts by weight |
| weight 20,000) | |
| Anatase-type titanium oxide (average primary | 30 parts by weight |
| particle size 150 nm) | |

The above-mentioned mixture was kneaded by a twin-screw extrusion kneader, and coarsely pulverized by a hummer mill, and then subjected to a pulverizing process by a turbo-mill pulverizer (made by Turbo Kogyo Co., Ltd.), and further subjected to a fine-particle classifying process by a gas-flow classifier utilizing the Coanda effect so that white base particles were manufactured. The resulting white base particles were used as white particles A. The volume-average particle size and the quantity of charge thereof were measured by using the aforementioned method.

### Production of White Particles B

To white particles A (100 parts by weight) was added 5 parts by weight of inorganic fine particles y1, and these were loaded into a Henschel mixer (made by Mitsui-Miike Machinery Co., Ltd.) and a mixing process was then carried out for 30 minutes, with a peripheral speed of stirring blades being set to 55 m/s, so that white particles B were obtained.

### Production of White Particles C

To white particles A (100 parts by weight) serving as base particles were added 0.5 parts by weight of inorganic fine particles x1 and 300 parts by weight of glass beads having an average particle size of 1 mm, and these were put into a 500-cc pot and subjected to a mixing process by using a turbular mixer (made by Glen Mills Inc.) at 100 rpm for 5 minutes. The glass beads were removed from the resulting mixture through a mesh sieve so that white particles C were obtained.

### Production of White Particles D

By carrying out the same method as that of white particles C except that in place of white particles A, white particles B were used, white-particles D were produced.

### Production of White Particles E

By carrying out the same method as that of white particles C except that in place of white particles A, white particles B were used and that in place of inorganic fine particles x1, inorganic fine particles x2 were used, white particles E were produced.

### Production of White Particles F

By carrying out the same method as that of white particles C except that in place of inorganic fine particles x1, inorganic fine particles x3 were used, white particles F were produced.

### Production of White Particles G

By carrying out the same method as that of white particles C except that in place of white particles A, white particles B were used and that in place of inorganic fine particles x1, 0.4 parts by weight of inorganic fine particles x2 and 0.1 part by weight of inorganic fine particles x4 were used, white particles G were produced.

### Production of White Particles H

By carrying out the same method as that of white particles C except that in place of inorganic fine particles x1, inorganic fine particles x6 were used, white particles H were produced.

### Production of White Particles I

By carrying out the same method as that of white particles C except that in place of inorganic fine particles x1, inorganic fine particles x5 were used, white particles I were produced.

### Production of Black Particles A

By carrying out the same method as that of white particles A except that in place of titanium oxide, 8 parts by weight of carbon black (average primary particle size: 25 nm) was used, black particles A were produced.

### Production of Black Particles B

To black particles A (100 parts by weight) was added 5 parts by weight of inorganic fine particles y2, and these were loaded into a Henschel mixer (made by Mitsui-Mike Machinery Co., Ltd.) and a mixing process was then carried out for 30 minutes, with a peripheral speed of stirring blades being set to 55 m/s, so that black particles B were obtained.

### Production of Black Particles C

To black particles A (100 parts by weight) serving as base particles were added 0.5 parts by weight of inorganic fine particles x1 and 300 parts by weight of glass beads having an average particle size of 1 mm, and these were put into a 500-cc pot and subjected to a mixing process by using a turbular mixer (made by Glen Mills Inc.) at 100 rpm for 5 minutes. The glass beads were removed from the resulting mixture through a mesh sieve so that black particles C were obtained.

### Production of Black Particles D

By carrying out the same method as that of black particles C except that in place of black particles A, black particles B were used, black particles D were produced.

### Production of Black Particles E

By carrying out the same method as that of black particles C except that in place of black particles A, black particles B were used and that in place of inorganic fine particles x1, inorganic fine particles x2 were used, black particles F were produced.

### Production of Black Particles F

By carrying out the same method as that of black particles C except that in place of inorganic fine particles x1, inorganic fine particles x3 were used, black particles F were produced.

### Production of Black Particles G

By carrying out the same method as that of black particles C except that in place of black particles A, black particles B were used and that in place of inorganic fine particles x1, 0.4 parts by weight of inorganic fine particles x2 and 0.1 part by weight of inorganic fine particles x5 were used, black particles G were produced.

### Production of Black Particles H

By carrying out the same method as that of black particles C except that in place of inorganic fine particles x1, inorganic fine particles x6 were used, black particles H were produced.

### Production of Black Particles I

By carrying out the same method as that of black particles C except that in place of inorganic fine particles x1, inorganic fine particles x4 were used, black particles I were produced.

Carrier A for Charging Positively Chargeable Display Particles

To 100 parts by weight of ferrite cores having an average particle size of 80 μm was added 2 parts by weight of fluorinated acrylate resin particles, and these materials were charged into a horizontal rotation blade type mixer, and mixed and stirred at 22° C. for 10 minutes under a condition of 8 m/sec in the peripheral speed of horizontal rotation blades, and the resulting mixture was then heated to 90° C., and stirred for 40 minutes so that carrier A was prepared.

Carrier B for Charging Negatively Chargeable Display Particles

To 100 parts by weight of ferrite cores having an average particle size of 84 μm was added 2 parts by weight of cyclohexylmethacrylate resin particles, and these materials were charged into a horizontal rotation blade type mixer, and mixed and stirred at 22° C. for 10 minutes under a condition of 8 m/sec in the peripheral speed of horizontal rotation blades, and the resulting mixture was then heated to 90° C., and stirred for 40 minutes so that carrier B was prepared.

### Example 1

### Production of Image Display Apparatus

An image display apparatus was manufactured in accordance with the following method so as to provide the same structure as shown in FIG. 1(a). Two glass substrates 11, each having a length of 80 mm, a width of 50 mm and a thickness of 0.7 mm, were prepared, and an electrode 15, made of an indium-tin oxide (ITO) film (resistance: 30Ω/□) having a thickness of 300 nm was formed on the surface of each of the substrates by a vapor deposition method. The electrode was coated with a coating solution prepared by dissolving 12 g of a polycarbonate resin in a mixed solvent containing 80 ml of tetrahydrofuran and 20 ml of cyclohexanone by using a spin coating method so that an insulating layer 16 having a thickness of 3 μm was formed thereon; thus, a pair of substrates with electrodes were obtained.

Black particles C (1 g) and carrier B (9 g) were mixed by a shaker (YS-LD, made by Yayoi Co., Ltd.) for 30 minutes so that display particles were charged. The resulting mixtures (21, 210) were put on a conductive stage 100, as shown in FIG. 6(a), and one of the substrates with electrodes was disposed with a gap of about 2 mm being set from the stage 100. Between the electrode 15 and the stage 100, a DC bias of +100V and an AC bias of 2.0 kV with a frequency of 2.0 kHz were applied so that black display particles 21 were allowed to adhere to the insulating layer 16. A predetermined amount of the black particles 21 was adhered thereto by adjusting the voltage applying time.

White particles C (1 g) and carrier A (9 g) were mixed by a shaker (YS-LD, made by Yayoi Co., Ltd.) for 30 minutes so that display particles were charged. The resulting mixtures (22, 220) were put on a conductive stage 100, as shown in FIG. 6(b), and the other substrate with electrode was disposed with a gap of about 2 mm being set from the stage 100. Between the electrode 15 and the stage 100, a DC bias of −100V and an AC bias of 2.0 kV with a frequency of 2.0 kHz were applied so that white display particles 22 were allowed to adhere to the insulating layer 16. A predetermined amount of the white particles 22 was adhered thereto by adjusting the voltage applying time.

As shown in FIG. 6(c), the substrate with electrode to which the black particles were adhered and the substrate with electrode to which the white display particles were adhered were superposed so as to have a gap of 50 μm by making adjustments by barrier ribs, and the peripheral portions of the substrates were bonded to each other with an epoxy based adhesive so that an image display apparatus was prepared. The volume-filling-ratio of the two kinds of display particles between glass substrates was 25%. The rate of contents of the white particles and the black particles was set to virtually 1/1 in a ratio of numbers of white particles/black particles.

### Examples 2 to 7/Comparative Examples 1 to 6

By using the same method as that of Example 1 except that those particles shown in Table 1 were used as the white particles and black particles, an image display apparatus was manufactured.

TABLE 2

| | White particles | | | | Black particles | | | | | | |
|---|---|---|---|---|---|---|---|---|---|---|---|
| | | Kinds of | Inorganic fine | | | Kinds of | Inorganic fine | | | | |
| | | base | particles adhered | | | base | particles adhered | | | Contrast durability | |
| | Kinds | particles | Kinds | ra | Kinds | particles | Kinds | rb | | Temperature | |
| | (μC/g) | (μC/g) | (μC/g) | (nm) | (μC/g) | (μC/g) | (μC/g) | (nm) | ra/rb | difference | Determination |
| Example 1 | C(+5) | A(+10) | ×1(−50) | 20 | C(−35) | A(−30) | ×1(−50) | 20 | 1.00 | 0.92 | B |
| Example 2 | D(+5) | B(+15) | ×1(−50) | 20 | D(−40) | B(−40) | ×1(−50) | 20 | 1.00 | 1.05 | B |
| Example 3 | E(+10) | B(+15) | ×2(−10) | 20 | E(−30) | B(−40) | ×2(−10) | 20 | 1.00 | 1.20 | A |
| Example 4 | F(+10) | A(+15) | ×3(−20) | 20 | F(−25) | A(−30) | ×3(−20) | 20 | 1.00 | 1.21 | A |
| Example 5 | G(+5) | B(+15) | ×2(−10)(80 wt %) | 20 | G(−30) | B(−40) | ×2(−10)(80 wt %) | 20 | 1.00 | 1.15 | B |
| | | | ×4(−45)(20 wt %) | 20 | | | ×5(+25)(20 wt %) | 25 | | | |
| Example 6 | C(+5) | A(+10) | ×1(−50) | 20 | D(−40) | B(−40) | ×1(−50) | 20 | 1.00 | 1.02 | B |
| Example 7 | H(+5) | A(+10) | ×6(−40) | 25 | H(−35) | A(−30) | ×6(−40) | 25 | 1.00 | 0.68 | C |
| Comparative | B(+15) | — | — | — | B(−40) | — | — | — | — | 0.35 | D |
| Example 1 | | | | | | | | | | | |
| Comparative | E(+10) | B(+15) | ×2(−10) | 20 | D(−40) | B(−40) | ×1(−50) | 20 | 1.00 | 0.56 | D |
| Example 2 | | | | | | | | | | | |
| Comparative | E(+10) | B(+15) | ×2(−10) | 20 | F(−25) | A(−30) | ×3(−20) | 20 | 1.00 | 0.57 | D |
| Example 3 | | | | | | | | | | | |
| Comparative | F(+10) | A(+15) | ×3(−20) | 20 | E(−30) | B(−40) | ×2(−10) | 20 | 1.00 | 0.54 | D |
| Example 4 | | | | | | | | | | | |
| Comparative | I(+20) | A(+15) | ×5(+25) | 25 | I(−35) | A(−30) | ×4(−45) | 20 | 1.25 | 0.47 | D |
| Example 5 | | | | | | | | | | | |
| Comparative | E(+10) | B(+15) | ×2(−10) | 20 | I(−35) | A(−30) | ×4(−45) | 20 | 1.00 | 0.39 | D |
| Example 6 | | | | | | | | | | | |

The inside of the parentheses indicates a quantity of charge.

Contrast

A DC voltage was applied to the image display apparatus in the following processes, and by measuring the reflection density of a display image obtained by the voltage application, the display characteristic was evaluated.

After alternately repeating voltage applications of +100 V and −100 V 10,000 times to the electrode on the upstream side in the visible direction, the density (black density) upon application of +100 V and the density (white density) upon application of −100 V were measured by using a reflection densitometer (Sakura DENSITOMETER PDA-65: made by Konica Minolta Holdings, Inc.). The other electrode was electrically grounded.

The density was measured at each of five arbitrary points. The average value thereof was used.

The contrast was evaluated based upon a density difference between the black color density and the white color density.

The contrast was evaluated based upon the following criteria: the contrast having 0.60 or more in the density difference was rated as acceptable (C) and the contrast having less than 0.60 was rated as rejected (D). In particular, the density difference of 0.90 or more was rated as preferable (B), and the density difference of 1.20 or more was rated as most preferable (A).

As clearly shown in the above Table, it can be understood that the image display apparatuses using the display particles having inorganic fine particles same in constitutional materials are excellent in contrast durability. In particular, Examples 3 and 4 in which the quantity of charge of the inorganic particles exists between the base particles of negative chargeability and the base particles of positive chargeability and the inorganic particles are surface-treated to be made hydrophobic show particularly excellent results.

1. Display particles that are used for an image display apparatus in which the display particles are sealed between two substrates at least one of which is transparent, and by generating an electric field between the substrates, the display particles are moved so that an image is displayed, wherein the display particles include positively chargeable display particles and negatively chargeable display particles, and the positively chargeable display particles and the negatively chargeable display particles are comprised of inorganic fine particles made of the same constituent materials to be adhered to the surfaces of base particles.

2. The display particles of claim 1, wherein provided that those inorganic fine particles to be adhered to the positively chargeable display particles are referred to as inorganic particles A, and those inorganic fine particles to be adhered to the negatively chargeable display particles are referred to as inorganic particles B as the inorganic fine particles made of the same constituent materials, the inorganic particles A and the inorganic particles B have surfaces of core particles treated with a surface-treating agent, the core particles are same in a chemical composition formula and the surface treating agent is same in a chemical structure.

3. The display particles of claim 1, wherein provided that those inorganic fine particles to be adhered to the positively chargeable display particles are referred to as inorganic particles A, and those inorganic fine particles to be adhered to the negatively chargeable display particles are referred to as inorganic particles B as the inorganic fine particles made of the same constituent materials, the inorganic particles A and the inorganic particles B have surfaces of core particles not-treated with a surface-treating agent, the core particles are same in a chemical composition formula and the surface treating agent is same in a chemical structure.

4. The display particles of claim 2, wherein the core particles are constituted of a material selected from the group consisting of silica, titanium oxide and aluminum oxide.

5. The display particles of claim 2, wherein an average primary particle size ra (nm) of the inorganic fine particles A and an average primary particle size rb (nm) of the inorganic fine particles B satisfy the following relational expressions:
5≦ra≦300;
5≦rb≦300; and
0.80≦ra/rb≦1.25.

6. The display particles of claim 2, wherein a quantity of charge Cx (μC/g) of base particles of the positively chargeable display particles, a quantity of charge Cy (μC/g) of base particles of the negatively chargeable display particles, a quantity of charge Cza (μC/g) of the inorganic fine particles A and a quantity of charge Czb (μC/g) of the inorganic fine particles B satisfy the following relational expressions:
Cy<Cza<Cx; and
Cy<Czb<Cx.

7. The display particles of claim 2, wherein a total content of the inorganic fine particles A and B is 0.01 to 30 parts by weight, relative to 100 parts by weight of the total amount of base particles of the positively chargeable display particles and base particles of the negatively chargeable display particles.

8. The display particles of claim 2, wherein a content of the inorganic fine particles A is 0.01 to 30 parts by weight, relative to 100 parts by weight of base particles of the positively chargeable display particles and a content of the inorganic fine particles B is 0.01 to 30 parts by weight, relative to 100 parts by weight of base particles of the negatively chargeable display particles.

9. The display particles of claim 1, wherein base particles of the positively chargeable display particles and the negatively chargeable display particles have respectively inorganic fine particles fixed on the surfaces thereof.

10. The display particles of claim 9, wherein an average primary particle size Ra (nm) of the inorganic fine particles to be fixed on the positively chargeable display particles and an average primary particle size Rb (nm) of the inorganic fine particles to be fixed on the negatively chargeable display particles satisfy the following relational expressions:
10≦Ra≦500;
10≦Rb≦500; and
0.4≦Ra/Rb≦2.0.

11. An image display apparatus, equipped with the display particles of claim 1.
